(19) United States
(12) Patent Application Publication
(10) Pub. No.: US 2005/0224299 A1
(43) Pub. Date: Oct. 13, 2005

(54) Elevator recessed car top for refuge area

(76) Inventors: San Aranggi Soemardjan, El Cajon, CA (US); John W. Koshak, Ramona, CA (US)

Correspondence Address: FROST BROWN TODD, LLC, 2200 PNC CENTER, 201 E. FIFTH STREET, CINCINNATI, OH, 45202, US

(21) Appl. No.: 10/823,110

(22) Filed: Apr. 13, 2004

(51) Int. Cl. B66B 5/16

(52) U.S. Cl. 187/406

(57) ABSTRACT

An elevator car with an extended refuge area is disclosed. The elevator car has a top surface with an opening, and a refuge area structure with a first hinge, a first panel, a second hinge, and a second panel. The first hinge is coupled to the right side of the opening. The right side of the first panel is connected to the first hinge. The left side of the first panel is coupled to the second hinge. The second panel has its right side coupled to the second hinge. The left side of the second panel rests on the left side of the opening in the top surface of the elevator car.

### FIELD OF INVENTION

The present invention relates generally to an apparatus for providing an elevator refuge area, and, in particular, to an elevator car having a recessed refuge area.

### BACKGROUND OF INVENTION

Maintenance workers periodically need to service elevator equipment located in an elevator shaft above an elevator car. To service this equipment, workers generally stand on the top of the elevator car and perform the necessary repairs. ASME guideline A17.1 2000 requires a vertical buffer space of at least 43 inches between the top of the elevator shaft and the top of the elevator car at the highest point the car can reach in the shaft. ASME guideline A17.1 2000 also requires the car's top to have a surface area of at least 5.4 ft² so that workers have sufficient space on which to stand while working. This required space is known in the art as the refuge area and ensures that workers have sufficient room to perform all necessary maintenance. However, complying with these guidelines can be costly because it requires erecting a unit above the elevator car having sufficient dimensions to satisfy the guidelines. Accordingly, there is a need for an elevator car which can reduce this costly overhead space requirement without reducing the required refuge area.

### SUMMARY OF INVENTION

The present invention is directed to an elevator car having a recessed car top for receiving a refuge area structure. The recessed car top addresses the problem of costly overhead space requirements because it places some or all of the refuge area in the elevator car, thereby decreasing the amount of space above the car required to satisfy refuge area guidelines.

One embodiment according to the present invention provides an elevator car having a top surface with an opening and a refuge area structure. The refuge area structure has a first panel which is foldably connected to the opening, and a second panel which is foldably connected to the first panel. The structure has both a closed position and an open position. In the closed position, the first and second panels of the refuge area structure are oriented coplanar within the opening in the top surface and fill the opening. In the open position, the first panel of the refuge area structure is oriented downwardly into the interior of the elevator car and the second panel is oriented substantially horizontally within the interior of the car and vertically below the opening. The second panel in the open position forms a work platform for supporting a worker.

In another embodiment according to the present invention, an elevator car with extended refuge area has a top surface with an opening. The perimeter of the opening has a left side and a right side. A refuge area structure has a first hinge, a second hinge, a first panel, and a second panel. The first hinge is coupled to the right side of the top surface perimeter. The first panel has a left side and a right side, the right side of the first panel is hingedly coupled to the first hinge. The left side of the first panel is coupled to the second hinge. The second panel has a left side and a right side, the right side of the second panel is hingedly coupled to the second hinge.

### BRIEF DESCRIPTION OF DRAWINGS

FIG. 1 shows an embodiment of an elevator car with a recessed top refuge area according to the present invention.

FIG. 1a shows an embodiment of the invention in which the refuge area structure is in a closed position.

FIG. 2 shows another embodiment of an elevator car with a recessed top refuge area according to the present invention.

FIG. 2a shows a refuge area structure in an elevator car according to an embodiment of the invention in a closed position.

FIG. 3 shows an embodiment of an elevator car with a recessed top refuge area according to the present invention with an escape hatch.

### DETAILED DESCRIPTION

The claimed invention will now be described with reference to the Figures, wherein like reference numerals refer to like elements.

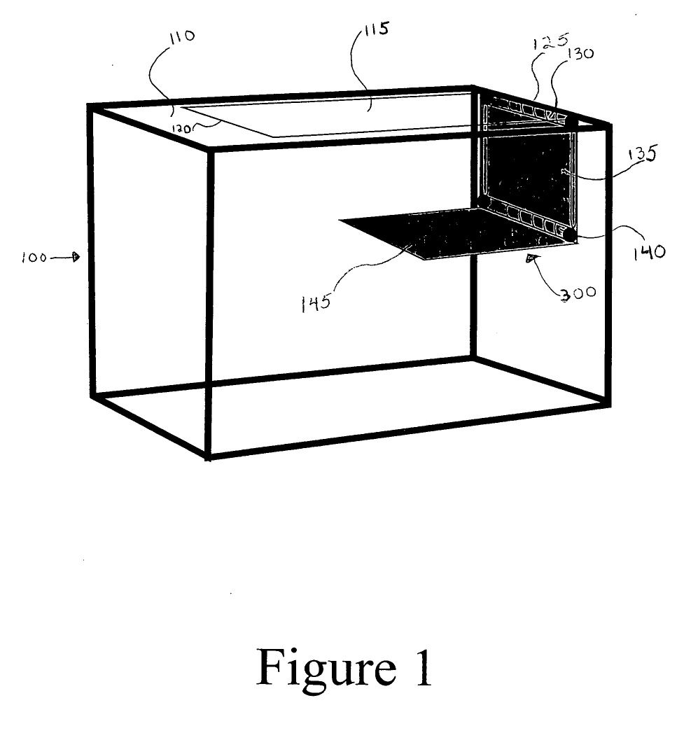

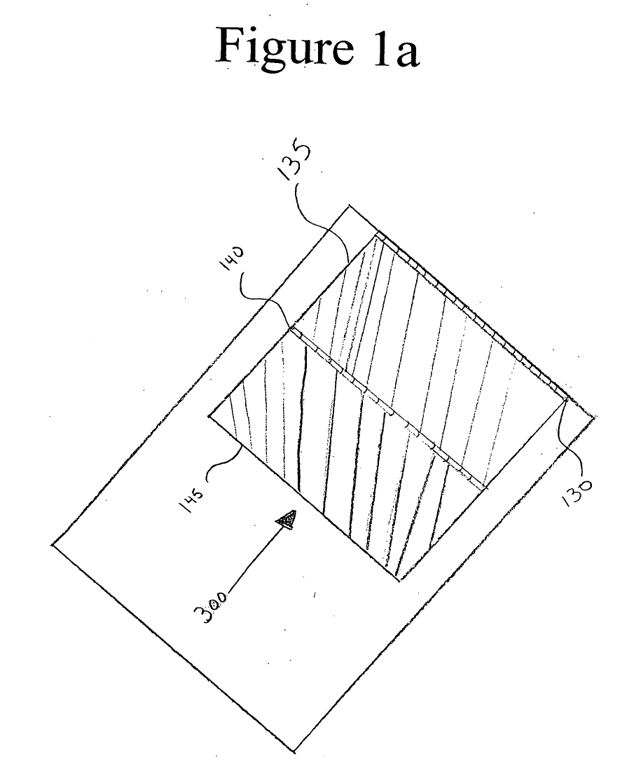

FIG. 1 illustrates an embodiment of a recessed refuge area in an elevator car according to the present invention. Elevator car 100 has a top surface 110 and an opening 115 in top surface 110. The perimeter of opening 115 has a left side 120 and a right side 125. A refuge area structure 300, as shown in a closed position in FIG. 1a, is used to form a platform in the elevator car on which workers can stand. Refuge area structure 300 is made from two sections, namely a first panel 135 and a second panel 145. First panel 135 is attached to right side 125 of the opening 115 by a first hinge 130. Hinge 130 allows first panel 135 to rotate around first hinge 130 and fold into the side of elevator 100. First panel 135 has a left side and a right side. The right side of panel 135 is attached to hinge 130 with methods known in the art. A second hinge 140 is attached to the left side of first panel 135 with methods known in the art. A second panel 145 has a right side and a left side, and the right side of second panel 145 is attached to second hinge 140 with methods known in the art.

In an embodiment according to the present invention the distance between the left and right sides of first panel 135 and the distance between the left and right sides of second panel 145 is at least two feet. Also, the length of first panel 135 and the length of second panel 145 is at least 2.7 feet. With a length of at least 2.7 ft and a width of at least 2 ft, the resulting surface area in this embodiment is at least 5.4 ft² which satisfies the ASME requirements. The dimensions of the recessed refuge area will depend upon the requirements of a specific application. Nevertheless, it is envisioned that the dimensions of the refuge area will satisfy ASME and local building code requirements.

As shown in FIG. 1, when refuge area structure 300 is in the open position, and thereby available for use by maintenance workers, first panel 135 is folded downward to the side wall of elevator car 100. Second panel 145 is rotated around second hinge 140 to form a horizontal platform. When second panel 145 is substantially in the horizontal position, second hinge 140 locks second panel 145 into place with methods known in the art so that maintenance workers can stand on and use second panel 145 as a platform. Maintenance workers who are standing on the platform formed by refuge area structure 300 in the open position are partly inside the elevator car because refuge area structure 300 is partly recessed in the elevator car. Advantageously, the invention reduces the amount of space above the elevator car needed to satisfy refuge area requirements, since part of the refuge area is in the elevator where the worker is standing, and the other part of the refuge area is outside the elevator car.

When refuge area structure 300 is in the closed position, as shown in FIG. 1a, first panel 135 and second panel 145 form part of top surface 110 and fill in opening 115, thereby forming a uniform closed elevator car top surface. To bring panel 135 back up to top surface 110, panel 135 is rotated around first hinge 130 so that it is horizontal and coplanar with top surface 110. When first panel 135 is horizontally positioned, first hinge 130 locks first panel 135 horizontally into place with methods known in the art. As shown in FIGS. 1 and 1a, second panel 145 is brought back up to top surface 110 by rotating panel 145 around second hinge 140 such that panel 145 is horizontal and coplanar with top surface 110. Refuge area structure 300 is in the closed position when panel 135 and second panel 145 are coplanar with top surface 110 and fill opening 115. In one embodiment, the left side of second panel 145 rests against protrusions (not shown) extending from the left side 120 of opening 115.

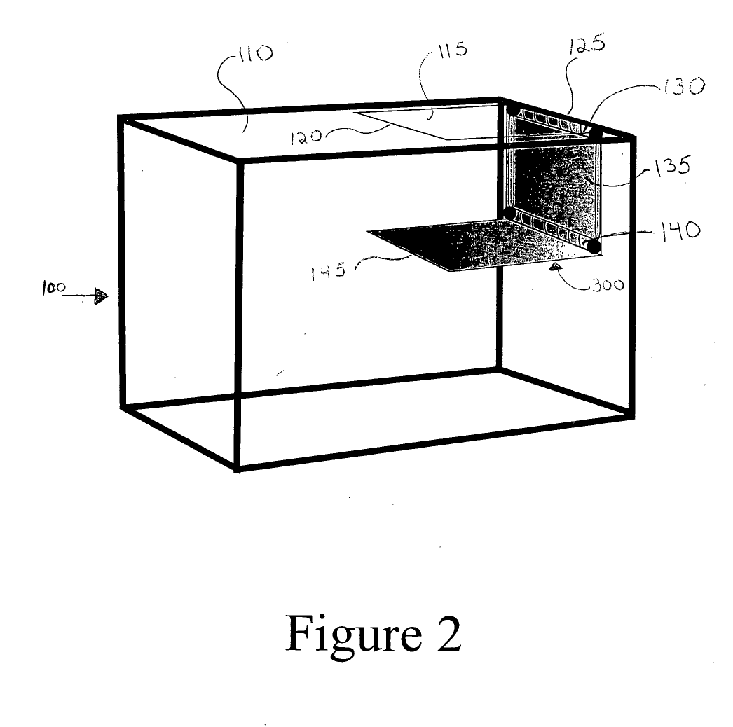

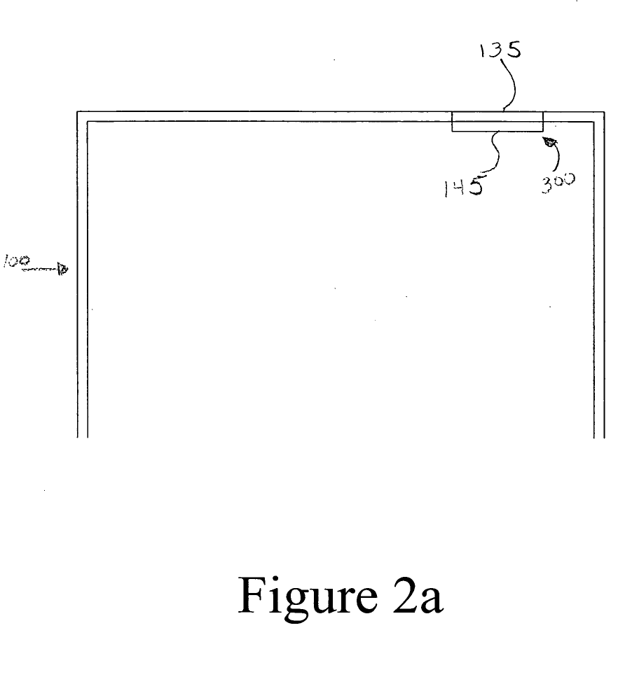

FIG. 2 shows another embodiment according to the present invention. In FIG. 2, opening 115 is made large enough to dispose within it the first panel 135. However, opening 115 is not large enough to also dispose second panel 145 into opening 115. Refuge structure 300 is still brought to the open position as described above for FIG. 1. When refuge area structure 300 is in the open position, and thereby available for use by maintenance workers, first panel 135 is folded downward to the side of elevator car 100, and second panel 145 is rotated around second hinge 140 to form a horizontal platform. When second panel 145 is substantially horizontal, second hinge 140 locks second panel 145 into place with methods known in the art so that a maintenance worker can stand on and use second panel 145 as a platform. A maintenance worker standing on the platform formed by the refuge area structure 300 while in the open position is partly inside the elevator car and partly outside the car because refuge area structure 300 is partly recessed in the elevator car. Advantageously, a smaller space above the elevator car is needed to satisfy refuge area requirements, since part of the refuge area is in the elevator where the worker is standing, and another part of the refuge area is outside the elevator car.

In an embodiment, when refuge structure 300 is in the closed position, as shown in FIG. 2a, second panel 145 does not fit into opening 115. Instead, second panel 145 fits snugly under first panel 135. To bring refuge structure 300 to the closed position as shown in FIG. 2a, first panel 135 is rotated around first hinge 130 so that first panel 135 is horizontally positioned and coplanar with top surface 110. When first panel 135 is horizontal, first hinge 130 locks first panel 135 horizontally into place with methods known in the art, and first panel 135 fills opening 115. Second panel 145 is rotated around hinge 140 so that it is directly under and fits snugly against first panel 135. When second panel 145 is positioned snugly under first panel 135, hinge 140 locks second panel 145 into place with methods known in the art, thus bringing refuge structure 300 to the closed position.

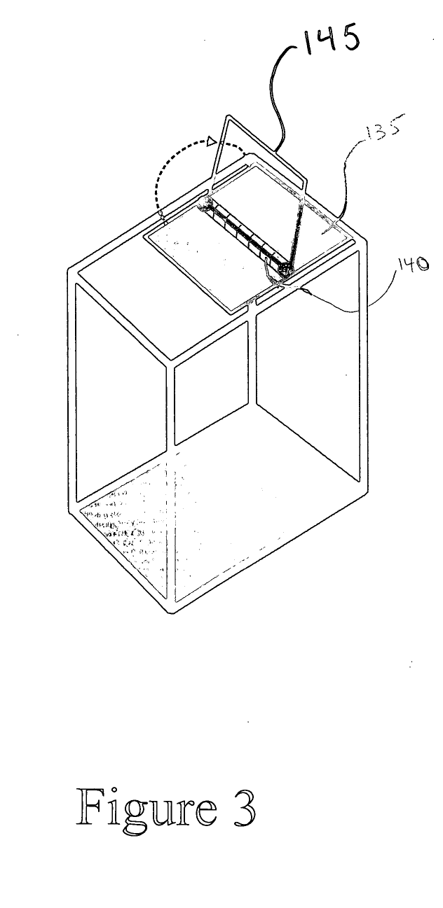

FIG. 3 shows the embodiment of FIG. 1 providing an escape hatch formed by refuge area structure 300. In this escape hatch, second panel 145 is rotated around second hinge 140, such that it serves as an opening through which a person can climb onto top surface 110.

For aesthetic purposes, when refuge area structure 300 is in the closed position, refuge structure 300 will generally be stowed away in the car such that it will not be readily or immediately detected by passengers. Any surface of refuge structure 300 that is visible in the closed position to a passenger can be decorated with the same surface treatment as the rest of the car interior and/or ceiling. For example, the surface of refuge structure 300 can be covered with a mirror, laminate, or any other surface covering.

While the invention has been particularly shown and described with reference to particular embodiments, those skilled in the art will understand that various changes in form and details may be made without departing form the spirit and scope of the invention as set forth in the appended claims.

1. An elevator car with a refuge area structure for extending the refuge area, the elevator car comprising:
a top surface of the elevator car, the top surface having an opening; and
a refuge area structure having a first panel foldably connected to the opening and a second panel foldably connected to the first panel, the structure having (i) a closed position in which the first and second panels are oriented coplanar within the opening in the top surface and fill the opening; and (ii) an open position in which the first panel is oriented downwardly into the interior of the elevator car and the second panel is oriented substantially horizontally within the interior of the car and vertically below the opening to form a work platform for supporting a worker.

2. The elevator car of claim 1, wherein the first panel and the second panel have a length substantially equal to the length of the opening in the top surface of the elevator car, and the sum of the widths of the first and second panels is substantially equal to the width of the opening.

3. The elevator car of claim 1, wherein the first panel and second panel each have a width and length substantially equal to the width and length of the opening.

4. The elevator car of claim 1, wherein the width of the first panel is at least two feet.

5. The elevator car of claim 1, wherein the width of the second panel is at least two feet.

6. The elevator car of claim 1, wherein the length of the first panel is at least 2.7 feet.

7. The elevator car of claim 1, wherein the length of the second panel is at least 2.7 feet.

8. The elevator car of claim 1, wherein the second panel is oriented substantially vertically above opening in the top of the elevator car to form an escape hatch.

9. An elevator car with extended refuge area, the elevator car comprising:
a top surface of the elevator car, the top surface having an opening, the perimeter of the top surface surrounding the opening having a left side and a right side; and
a refuge area structure, the structure having a first hinge, a second hinge, a first panel, and a second panel, the first hinge coupled to the right side of the top surface perimeter, the first panel having a left side and a right side, the right side hingedly coupled to the first hinge, the second hinge coupled to the left side of the first panel, the second panel having a left side and a right side, the right side hingedly coupled to the second hinge.

10. The elevator car of claim 9, wherein the refuge area structure has a closed position and an open position, the closed position having the first and second panels oriented coplanar with the opening in the top surface and fill the opening, the open position having the first panel oriented downwardly into the interior of the elevator car and the second panel oriented substantially horizontally within the interior of the elevator car and vertically below the opening in the top surface to form a work platform for supporting a worker.

11. The elevator car of claim 9, wherein the distance between the left side and right side of the first panel is about two feet.

12. The elevator car of claim 9, wherein the distance between the left side and right side of the second panel is about two feet.

13. The elevator car of claim 9, wherein the left and right sides of the first panel and the left and right sides of the second panel are about 2.7 feet in length.

14. The elevator car of claim 9, wherein the second panel is oriented substantially vertically above the opening in the top of the elevator car to form an escape hatch.
